(19) United States
(12) Patent Application Publication
(10) Pub. No.: US 2007/0112739 A1
(43) Pub. Date: May 17, 2007

(54) INTELLIGENT MOBILE SEARCH CLIENT

(75) Inventors: Theodore C. Burns, Menlo Park, CA (US); Pankaj Shah, Palo Alto, CA (US); Eric S. Chu, Mountain View, CA (US); Garth R. Patil, Stanford, CA (US); Markus Nordvik, San Francisco, CA (US); Michael S. Stachowiak, San Francisco, CA (US)

Correspondence Address: PILLSBURY WINTHROP SHAW PITTMAN LLP, P.O. BOX 10500, MCLEAN, VA, 22102, US

(73) Assignee: 4Info, Inc., Palo Alto, CA (US)

(21) Appl. No.: 11/458,672

(22) Filed: Jul. 19, 2006

Related U.S. Application Data
(60) Provisional application No. 60/701,397, filed on Jul. 19, 2005.

(51) Int. Cl. G06F 17/30

(52) U.S. Cl. 707/3

(57) ABSTRACT

A system and method is provided to provide information services to a plurality of mobile clients where the mobile clients can be any networked device including cell-phones, PDAs and other wireless devices. The system utilizes available communications protocols to submit requests and receive responses that can be information services and mobile content, such as ring tones and wallpaper. The system permits a user to conduct unstructured searches and to use hierarchical navigation systems for generating content-specific structured search queries and datasets. Searches can be based on a prior history of searches, geographical location, stated preferences and profile information associated with the user.

### CROSS-REFERENCE TO RELATED APPLICATIONS

The present application claims priority from provisional patent application No. 60/701,397 entitled “Intelligent Mobile Search Client,” filed Jul. 19, 2005 which is incorporated herein by reference and for all purposes. The present Application is also related to U.S. non-provisional patent application Ser. No. 11/345,610 entitled “Short Query-based System and Method for Content Searching,” filed Jan. 31, 2006 and from non-provisional patent application Ser. No. 11/345,628 entitled “Prioritization of Search Responses System and Method,” filed Jan. 31, 2006, and from non-provisional patent application Ser. No. 11/345,627 entitled “Automated Transfer of Data from PC Clients,” filed Jan. 31, 2006, which applications are incorporated herein by reference and for all purposes.

### BACKGROUND OF THE INVENTION

1. Field of the Invention

The present invention generally relates to information searching techniques. More particularly, the present invention relates to the provision of access to information using communications devices with limited capabilities.

2. Description of Related Art

Currently the mobile content market consists of fragmented information providers. Applications and services are created for content verticals such as sports, weather, finance, yellow pages, entertainment, ring tones, games, etc. A service (client or WAP) does not currently exist that offers all of the content choices above or a way to search within them easily.

Those services that offer search functionality generally search content that is not relevant or adaptable to user's devices, such as HTML images and PC oriented websites. While several search companies have enabled users to search WAP sites solutions that facilitate searches for content appropriate for the user are not offered. For example, in searching for ring tones or sports news, prior art search functionality is limited to a hierarchical navigation and does not take into account past searches or preferences. Navigation is further complicated because users are usually only provided one means of navigation such as a structured search or hierarchical search. Further problems arise from inability of client software to synchronize information between mobile and fixed platforms.

### BRIEF SUMMARY OF THE INVENTION

These and other problems are resolved in embodiments of the invention that provide, inter alia, an intelligent mobile client that can interact with core search technology and typically provides alternative navigation methods. The mobile client can be any suitable device configured to communicate with a network and typically includes an operating environment such as J2ME, BREW, Symbian, Palm and Blackberry compatible systems. In certain embodiments the client enables users to search for information services and mobile content, such as ring tones and wallpaper, using unstructured searches and through hierarchical navigation systems for generating content-specific structured search queries and datasets. Certain embodiments can store frequently used information, such as stock quotes and city identifiers for obtaining weather and other information and users can navigate personalized content areas to obtain updated information.

In many embodiments, information associated with a user and a mobile client can be maintained in a plurality of locations on a network. Upon connecting the mobile client, information can be synchronized among the plurality of locations. The information typically comprises personalization data including identifying information, authentication information, search histories, location information related to a plurality of locations associated with the user and preferences provided by the user.

### BRIEF DESCRIPTION OF THE DRAWINGS

These and other aspects of an embodiment of the present invention are better understood by reading the following detailed description of the preferred embodiment, taken in conjunction with the accompanying drawings, in which:

FIG. 1 is a block diagram of one example of an embodiment of the invention;

FIG. 2 is a block diagram showing detail of client and MMP related components;

FIG. 3 is a block diagram showing detail of components related to the provision of applications and other services;

FIG. 4 is a flowchart of an example of an initialization process for a mobile client;

FIG. 5 is a flowchart of an example of accessing content and recommendations; and

FIG. 6 is a flowchart of an example of maintaining personalized content.

### DETAILED DESCRIPTION OF THE INVENTION

Embodiments of the present invention will now be described in detail with reference to the drawings, which are provided as illustrative examples so as to enable those skilled in the art to practice the invention. Notably, the figures and examples below are not meant to limit the scope of the present invention. In the drawings, like components, services, applications, and steps are designated by like reference numerals throughout the various figures. Where certain elements of these embodiments can be partially or fully implemented using known components, only those portions of such known components that are necessary for an understanding of the present invention will be described, and detailed descriptions of other portions of such known components will be omitted so as not to obscure the invention. Further, the present invention encompasses present and future known equivalents to the components referred to herein by way of illustration.

Embodiments of the invention provide an intelligent mobile client that can interact with core search technology and typically provides alternative navigation methods. The mobile client can be any suitable device configured to communicate with a network and typically includes an operating environment such as J2ME, BREW, Symbian, Palm and Blackberry compatible systems. In certain embodiments the client enables users to search for information services and mobile content, such as ring tones and wallpaper, using unstructured searches and through hierarchical navigation systems for generating content-specific structured search queries and datasets. Certain embodiments can store frequently used information, such as stock quotes and city identifiers for obtaining weather and other information relevant to the user. Relevant information may be provided to and users in personalized content areas that can be navigated for obtaining updated information.

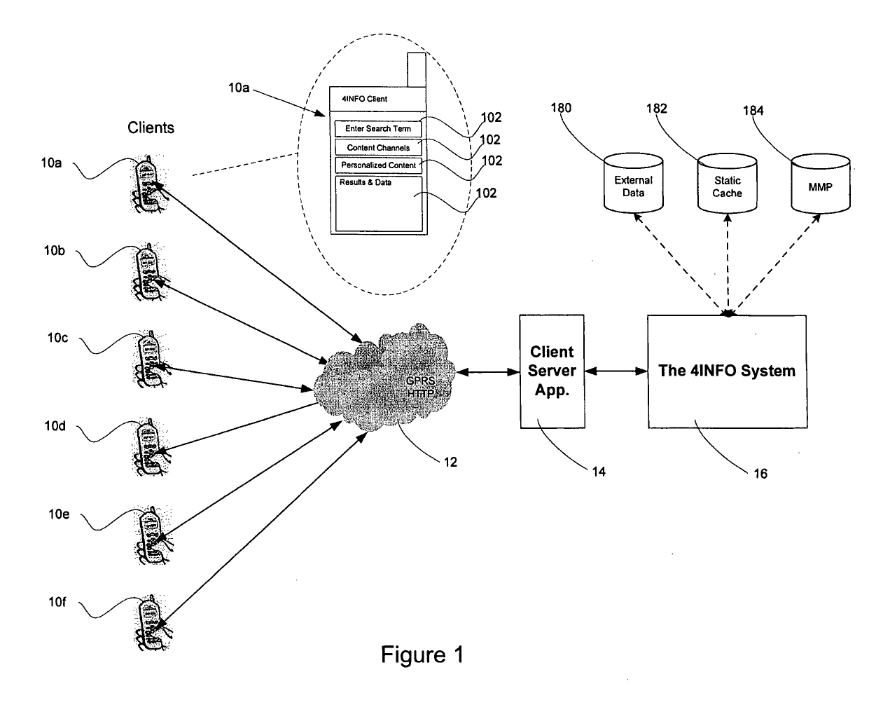

Referring to FIG. 1, embodiments of the invention comprise mobile clients 10a-10f and a core system 16. The core system 16 typically provides access to a plurality of functional components including recommendation engines; personalized channel manager; one or more channels of recommended services, information, and mobile content (including, e.g. a 4YOU Channel); recent search memory; server side update managers; channel update manager; advertising engines; personalized content list managers; channel synchronization, authentication and identification tools; media downloaders (such as WAP download advertisements); channel creation tools; mobile content search tools; structured search tools; and user profiling tools.

In certain embodiments, a recommendation engine provides links to content such as ring tones, information services, and games. The recommendations are typically made based on factors including current physical location, preferred physical location, specified physical location, a history of previous searches and saved personal information. The recommendations can be customized by user and by mobile device. Upon execution of a query by the user, query type (Sports, Ring tones, etc) may be stored in a mobile message processor (hereinafter “MMP”). Based on the frequency of searches for a particular category (or, vertical), the query may be assigned a weight that operates to prioritize the query in comparison to other services. This weight can be used to establish priorities of future requests. Content services, such as ring tones and wallpapers, can be served to any user having a profile corresponding to a valid profile stored in the MMP. In many embodiments, information located and visited by a user may be retained in a history associated with the user and maintained in the MMP. In certain embodiments, location information can be collected manually from a user through any suitable data entry system such as a mobile client or personal computer.

In certain embodiments, location information may be derived from searches and search requests that include manually entered city, zip code and other geographical information. In certain embodiments, frequently used location objects can be assigned greater weight and may be used to indicate one or more default locations. Default locations may be updated when a user manually enters different location information or establishes a new pattern of activity conveying, for example, geographical information common to multiple queries. It will be appreciated that the location of certain mobile devices can also be identified based on geographical information generated by the mobile device or by a network that detects the mobile device through, for example, signal triangulation, communication between mobile device and transmitters/receivers and interpretation of global positioning satellite (“GPS”) information. Location information provided by network, GPS or by other means may be used to establish default location information, establish system usage patterns by the user and to modify weights applied to queries or to query responses.

In certain embodiments, a personalized channel manager enables a user to pick channels of information including content requested or sought by the user for viewing on a client device 10f-10f Content can be viewed on a personal computer using a suitable browser, a WAP-enabled and other suitable devices. In many embodiments, the channel manager bases information selections on factors including user defined preferences entered via personal computer, WAP enabled devices, etc.

In at least some embodiments, the personalized channel manager can be used to provide the client with personal information including authentication information, credit card information, address, and content preferences. Personal information may be provided to the channel manager using a personal computer, WAP enabled device and messaging systems such as SMS. Personal information is typically stored in a user profile and associated with one or more identifiers including user ID, password and mobile identification number (hereinafter “MIN”). Upon connecting to the system 16, a user is typically required to provide authenticating information such as a user name and password. It will be appreciated that other forms of authentication may be used including, for example, biometric identification. Upon authenticating a user at a client device 10a-10f, the system 16 may update the client device 10a-10f with appropriate information. Users may also be able to update a list of predetermined channels.

In certain embodiments, information related to prior searches can be cached on a client device 10a-10f and associated with channels identified for searching by a user. Cached search terms can be used to perform subsequent searches and to qualify new search requested by a user. In certain embodiments, clients 10a-10f can receive server-side updates for all content channels such as financial quotes, sports scores, and new channels. Server side updates are typically provided based on factors including saved preferences and search terms with clear results.

In certain embodiments, clients 10a-10f can receive channel updates that change menus provided to users of the clients 10a-10f and add new channels for navigation. Channel updates are typically provided based on factors including user location, last update, and download source. In certain embodiments, one or more advertising engines serve contextual advertising to users via GPRS in text and graphic formats. Context recognition is typically performed when user profile, location, and preferences have been stored in, for example the client 10a-10f, MMP, and so on. In certain embodiments, personalized content lists are maintained on clients 10a-10f. Personalized content lists can be used to retrieve quick updates from content servers. Personalized content lists are typically updated based on factors including user preferences and prior activities including prior saving and manual alteration of content.

In certain embodiments, client identification codes may be configured at a PC by using the MIN. In some embodiments, the system 16 can compile a client configuration, including an embedded MIN, for user download when a user provides context information such as phone make, model, carrier, and MIN. In these embodiments, a user may use a PC to seamlessly synchronize mobile client 10a-10f with personalized preferences and can further manage content from the PC. In using a PC, users can establish a unique ID that allows the system 16 to identify users in order to provide recommendations and targeted content.

In certain embodiments, one or more media downloaders enable users to download, view and play different types of information on mobile devices 10a-10f. Media players 10a-10f and file type can be selected based on factors including make, model, and OS. Media downloaders may be implemented using any suitable protocol such as WAP, GPRS, and UMTS. Download may be initiated based on a call from the mobile client 10a-10f to application and content servers. The download may be initiated upon identification and authentication of a user by the system and verification of registration and account validity and that the mobile 10a-10f device is compatible with the system. Compatibility will typically be identified through an agent that can be transmitted in an HTTP request.

In certain embodiments, a channel creation engine enables third parties to add content for mobile clients 10a-10f. Content can be entered in various forms, using any suitable entry device and will be subsequently entered into content servers 180. Content publishing is typically performed by updating information using, for example, RSS, XML and manual entry. Upon entry of information, the third party can designate templates needed to display the content.

In certain embodiments, mobile content searching can be performed by indexing and parsing search tools provided by core system 16. Parsing typically includes receiving and determining content of user queries and returning results based on indexed mobile content including ring tones, wallpapers, and games. Subsequently, device 10a-10f types can be identified and appropriately formatted information delivered to the devices 10a-10f. Typically, a compatibility assessment can determine appropriate file type based on handset compatibility. For example, the assessment can determine whether the mobile device 10a-10f can receive wallpaper in “.png,” “.gif” or, “jpg” formats.

In certain embodiments, users can initiate structured searches using a client 10a-10f. The structured searches may be conducted by querying specific subsets of data stored in content servers 180. Structured searches can be performed by limiting search passes to one channel and requesting specific data points such as city and state in order to help narrow search options. It will be appreciated that structured and unstructured searches can be performed using suitable search engine technologies.

In certain embodiments, user personalization profiles are maintained by processes similar to processes used to store user preferences in the MMP for SMS searches. The MMP is typically configured to maintain histories of recent searches and geographical locations as established by configuration and a history of prior queries. Personalization profiles can be used in a variety of search techniques and can extend beyond searches initiated through SMS and WAP by a client. The MMP can serve as a system intelligence and analyzer component and data warehouse for recommendation tools. The analyzer may interact with one or more data warehouses to supplement and enhance internal lexicons, grammars, aliases, user profiles, and other system specific information. In various embodiments the analyzer builds additional information based on past user behavior using a tools including machine learning and probability engineering tools.

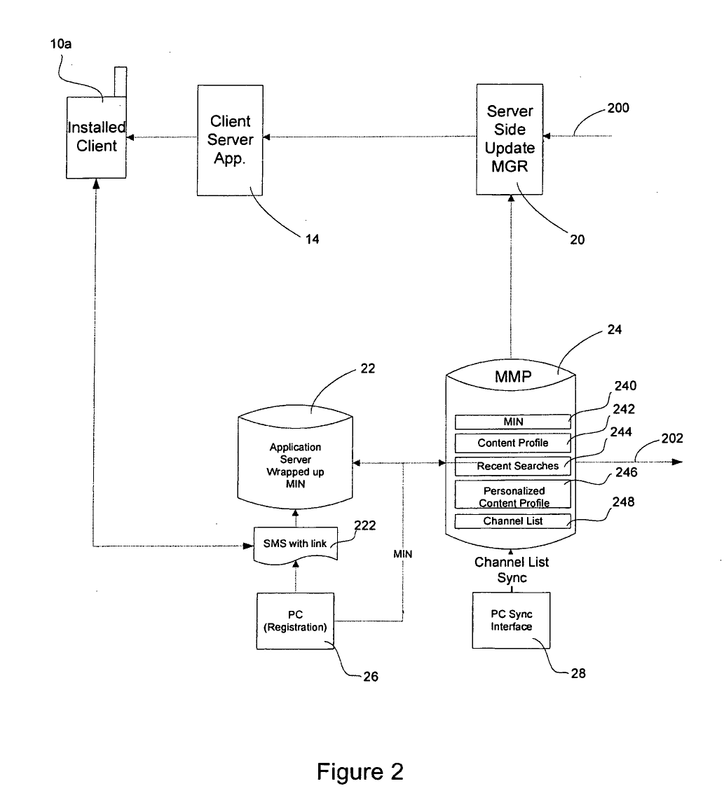

FIG. 2 diagrammatically illustrates the relationship between a mobile client 10a and a system in one example of an embodiment of the invention. Identity of a mobile client 10a can be provided to various components of the system using, for example, personal computer (PC) 26. PC 26 may be used to register the mobile client 10a with the system through provision of phone information carrier, make, and model and a MIN 240. Registration information can be maintained with other information associated with the user and mobile device 10a and used in MMP 24 operations. Communications in the system can be effected using SMS or other suitable protocols. A text message 222 is typically sent to the user by means of a WAP push link to the download on application server 22. The MIN is typically used to configure an application resident on the application server 22 and associated with the user. By activating the link the user can download the configured application together with an embedded unique id that will allow future synchronization with the PC. In operation, the application can obtain information by connecting to a server side update manager 20. The server side update manager can connect to a plurality of applications and services including applications and servers, including those provided by MMP 24, and content servers for maintaining preferences and content. Users can edit preferences stored in the MMP via a PC interface 28. Thus management and maintenance of user preferences such as location, billing information and content preference can be facilitated on a user's phone or device.

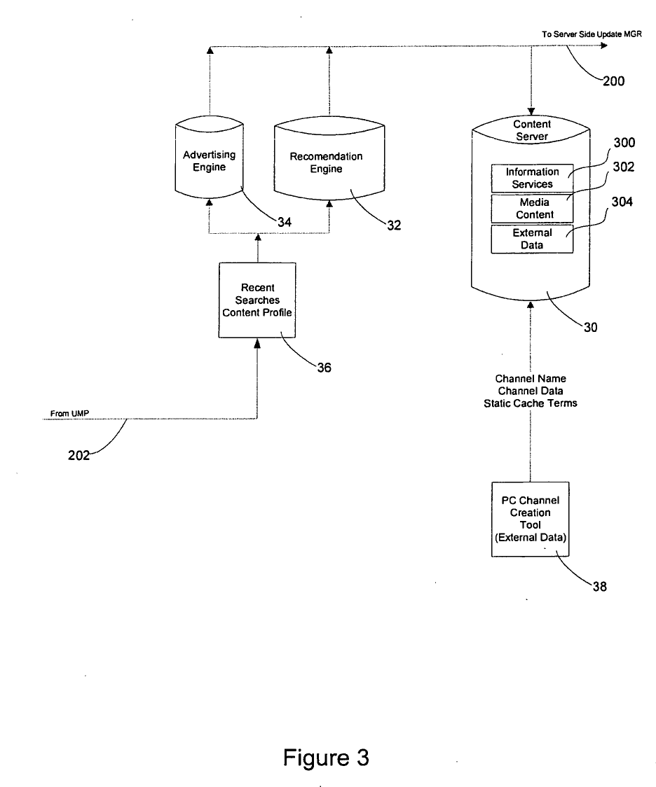

Referring to FIG. 3, content and services can be distributed from a content server 30. The content and services can be provided in a variety of formats such as information services 300, media content 302 including ring tones (302), and web service applications 304 for connecting to external data. Content providers can utilize PC Channel Creation 38 for various purposes including creation, deletion and addition of content services. In one example, a user can make a call for specific pieces of information such as sports scores. Responsive to the call, associated data is typically retrieved from an appropriate content server and transmitted to Server Side Update Manager 200. Before the data is forwarded to the user, the information packet can be augmented with additional information including, for example, relevant advertising 34 and user-targeted recommendations 32. The additional information is typically identified based on prior searches 36 and other relevant content collected from the MMP 24. Based on monitoring and feedback related to end user experience, MMP can be updated to include specific data points, advertisements targeted by user and by query, recommendations based on user and on query, and other associated content.

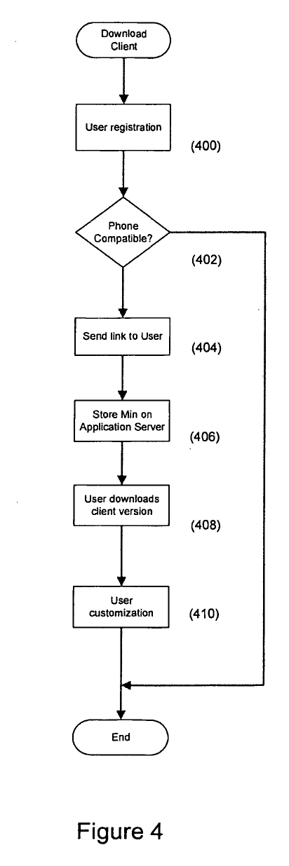

The flowchart of FIG. 4 illustrates an example of a client initiation process in one embodiment of the invention. At step 400, a user contacts system 16 and registers a client device 10a-10f by, for example, entering information describing the client device 10a-10f and by providing authentication information including a MIN. At step 402, system 16 determines whether the client device 10a-10f meets predetermined compatibility criteria. Criteria may include minimum operational capabilities, performance characteristics, software compatibilities and so on. Where the device 10a-10f fails to meet minimum criteria, the process ends. Otherwise, at step 404, the system 16 typically stores the MIN entered by the user and transmits information to client device 10a-10f that enables further configuration of system-client relationship. In one example, the information can be a link directing client device 10a-10f to a network location configured by system 16. At step 406, system 16 may store client information including MIN in one or more application servers 22. Typically, the MIN is stored in a wrapper configured for the client device 10a-10f. At step 408, the user may extract a link from the information received from the system 16, where the link may include a URL. At step 410, the user can set preferences using a web browser or the client device 10a-10f.

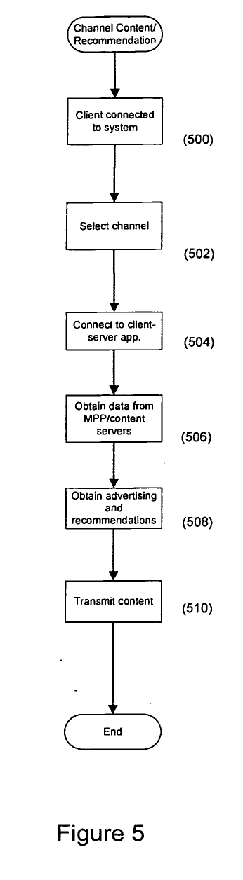

Referring now to FIG. 5, an example of a process for obtaining content and recommendations is illustrated. At step 500 in the example, the user connects to the system 16 from mobile device 10a-10f. In certain embodiments, the connection can be established using GPRS and HTTP protocols and standards. At step 502, the user chooses a channel for searching. Typically, selection can be made by clicking on links displayed at the mobile device 10a-10f. Upon selection of a channel, a content server may be connected to a client server application 14 at step 504. At step 506, relevant data from the application server 14 and MPP. At step 508, the client server application may obtain relevant content from an advertising engine and recommendations engine based on the user's request. At step 510, the system 16 may transmit information, content, advertisements and recommendations to the mobile device 10a-10f.

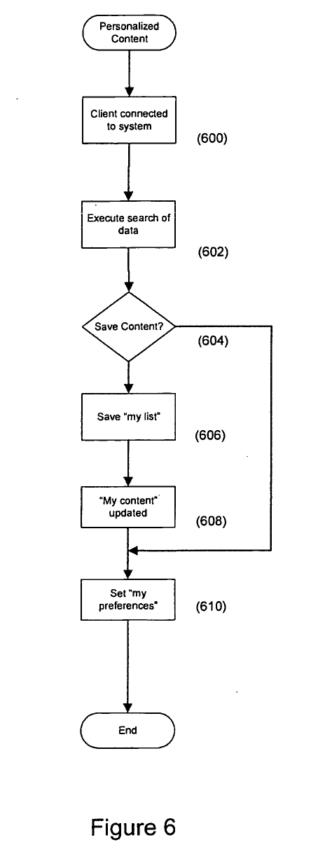

FIG. 6 illustrates an example of a process for providing personalized content. At step 600, the user typically connects to the system 16 from mobile device 10a-10f. In certain embodiments, the connection can be established using GPRS and HTTP protocols and standards. At step 602, the user can configure a search for data. The search can be a structured search or an unstructured search as desired by the user or as necessitated by system requirements. The search may be configured using prior searches and can be created and amended by input from the user. At step 604, the user may choose to record portions of the content or links to selected content retrieved by the search. In storing content and content links, targeted by user and by query specific data points and links may be stored in a user list at step 606. User list can be maintained on a client device, on a server or on both client and server as necessary to facilitate personalization and access from one or more client devices. In some embodiments, user lists can be shared between client devices, groups of users and all users.

At step 608, a user profile may be updated to include information related to a current search. The information can include search terms and results that may be added to a history of searches and results associated with the user. In certain embodiments, the updates have immediate effect. In some embodiments the updates become effective when the user next connects to the system 16. In certain embodiments, a user preferences and profile information may be updated at step 610. User preferences and profile may include elements that can be modified using a client device 10a-10f or other processing devices, such as a PC. Entry of information for certain user preferences and profile entries may be controlled by a user whereby automatic update or modification may be enabled by the user. Further, certain user preferences and profile entries can be maintained by the system without user control or action.

It is apparent that the above embodiments may be altered in many ways without departing from the scope of the invention. Further, the invention may be expressed in various aspects of a particular embodiment without regard to other aspects of the same embodiment. Still further, various aspects of different embodiments can be combined together. Accordingly, the scope of the invention should be determined by the following claims and their legal equivalents.

What is claimed is:

1. A method for optimizing media access in a mobile device, comprising:
receiving a query from a mobile device;
determining context associated with the mobile device, wherein the context includes a current location of the mobile device;
executing a search based on the query and the context; and
serving results of the executed search to the mobile device.

2. A method according to claim 1, wherein the step of determining context includes identifying the mobile device based on registration information maintained on a server.

3. A method according to claim 2, wherein the registration information includes a mobile identification number.

4. A method according to claim 1, and further comprising the step of identifying a user of the mobile device.

5. A method according to claim 4, wherein the step of identifying includes authenticating the user.

6. A method according to claim 1, wherein the step of determining context includes identifying the current location.

7. A method according to claim 1, wherein the current location is identified as a default location based on a history of prior searches.

8. A method according to claim 1, wherein the current location is detected.

9. A method according to claim 1, wherein the current location is identified from patterns of prior system usage by the user.

10. A method according to claim 1, and further comprising the step of serving advertising to the mobile device based on the results.

11. A method according to claim 1, and further comprising the step of serving advertising to the mobile device based on the current location.

12. A method according to claim 1, and further comprising the step of serving recommendations to the mobile device based on the results.

13. A method according to claim 1, and further comprising the step of serving recommendations to the mobile device based on the current location.

14. A system for optimizing media access in a mobile device, comprising:
an authentication tool configured to identify and authenticate a user of a mobile device;
a mobile message processor configured to receive a query and generate a search based on context associated with the user, wherein the context includes a current location of the mobile device;
one or more search engines configured to execute portions of the search and provide results prioritized according to the context; and
one or more content servers adapted to present the results on the mobile device.

15. A system according to claim 14, and further comprising a recommendation engine configured to augment the results with recommendations targeted to the user.

16. A system according to claim 14, and further comprising an advertising engine configured to augment the results with contextual advertising.

17. A system according to claim 14, and further comprising one or more channels of information.

18. A system according to claim 14, and further comprising one or more channels of recommended services,

19. A system according to claim 14, wherein the generated search is an unstructured search.

20. A system according to claim 14, wherein the search is a structured search generated using hierarchical navigation systems.
